(19) United States
(12) Patent Application Publication
(10) Pub. No.: US 2026/0153117 A1
(43) Pub. Date: Jun. 4, 2026

(54) UNIVERSAL JOINT

(71) Applicant: KE HUNG INDUSTRIAL CO., LTD., Taichung City (TW)

(72) Inventor: HSIN-NIEN CHEN, Taichung City (TW)

(21) Appl. No.: 18/965,149

(22) Filed: Dec. 2, 2024

(51) Int. Cl. F16C 11/06; F16C 11/10

(52) U.S. Cl. CPC F16C 11/0623; F16C 11/0604; F16C 11/10

(57) ABSTRACT

A universal joint is provided, wherein the universal joint includes: a socket including a connecting slot and a assembling structure configured to be assembled with a first external device, the connecting slot including first inner surfaces and second inner surfaces which are different in shape and alternatively and circumferentially arranged, the assembling structure being; and a connecting rod including a first end portion swingably received in the connecting slot and rotatable with the socket, and a second end portion configured to be assembled with a second external device, the first end portion including first side surfaces and second side surfaces which are different in shape and alternatively and circumferentially arranged, the first side surfaces and the second side surfaces facing the first inner surfaces and the second inner surfaces, respectively.

### BACKGROUND OF THE INVENTION

### Field of the Invention

The present invention relates to a joint, particularly to a universal joint.

### Description of the Prior Art

In general, hand tools, such as open-end wrenches, socket wrenches and screwdriver bits, are commonly used to assist with locking or disassembly operations. When operation environments are constrained, for example, in narrow spaces or corners, a universal joint capable of swinging is required.

The conventional universal joint typically includes a socket and a connecting rod. An end of the connecting rod is provided with a polygonal ball head, and the polygonal ball head is received within the socket. Through the engagement between the polygonal ball head and the socket, the connecting rod is allowed to swing to adjust the working angle.

However, in the conventional universal joints, the polygonal ball head of the connecting rod is composed of a plurality of surfaces which are identical in size and shape. These identical surfaces are equiangularly arranged. As a result, the contact area between each surface and the inner surface of the socket is small, and the angles between neighboring two of the identical surfaces are large. Consequently, the torque transmission efficiency and performance between the socket and the connecting rod are poor, and the contact portions between the socket and the connecting rod are prone to damage.

The present invention is, therefore, arisen to obviate or at least mitigate the above-mentioned disadvantages.

### SUMMARY OF THE INVENTION

The main object of the present invention is to provide a universal joint which can operate flexibly, smoothly and multi-directionally, with a large swinging range, and is capable of effectively transmitting torque.

To achieve the above and other objects, a universal joint is provided, wherein the universal joint includes: a socket including a connecting slot and a assembling structure oppositely arranged, the connecting slot including a plurality of first inner surfaces and a plurality of second inner surfaces, the plurality of first inner surfaces and the plurality of second inner surfaces being different in shape and being alternatively and circumferentially arranged, the assembling structure being configured to be assembled with a first external device; and a connecting rod including a first end portion and a second end portion oppositely arranged, the first end portion being swingably received in the connecting slot and rotatable with the socket, the first end portion including a plurality of first side surfaces and a plurality of second side surfaces, the plurality of first side surfaces and the plurality of second side surfaces being different in shape and being alternatively and circumferentially arranged, the plurality of first side surfaces and the plurality of second side surfaces facing the plurality of first inner surfaces and the plurality of second inner surfaces, respectively, the second end portion being configured to be assembled with a second external device.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is another exploded view of an exemplary embodiment of the present invention;

FIGS. 4 to 5 are cross-sectional views of an exemplary embodiment of the present invention;

FIG. 6 is a drawing of a connecting rod of an exemplary embodiment of the present invention; and

FIG. 7 is a drawing of a socket of an exemplary embodiment of the present invention.

### DETAILED DESCRIPTION OF THE PREFERRED EMBODIMENTS

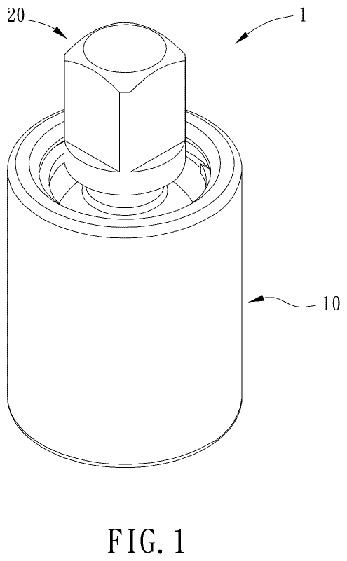

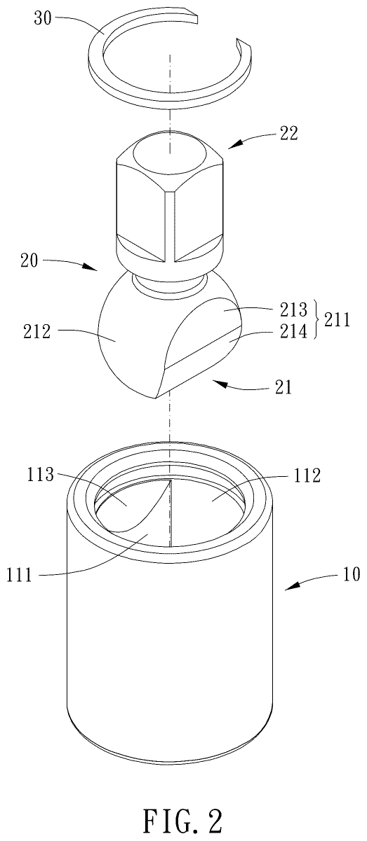

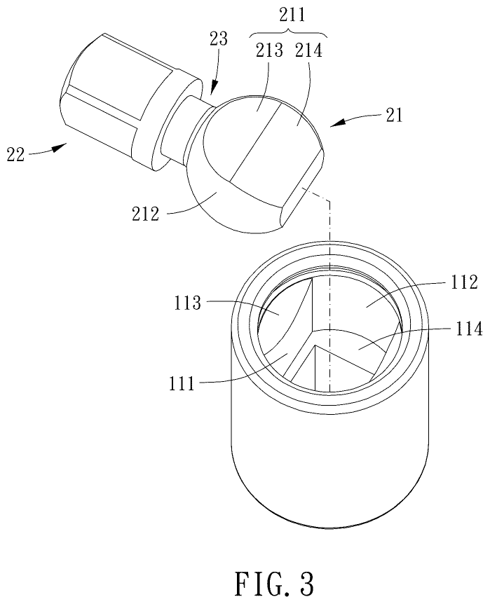

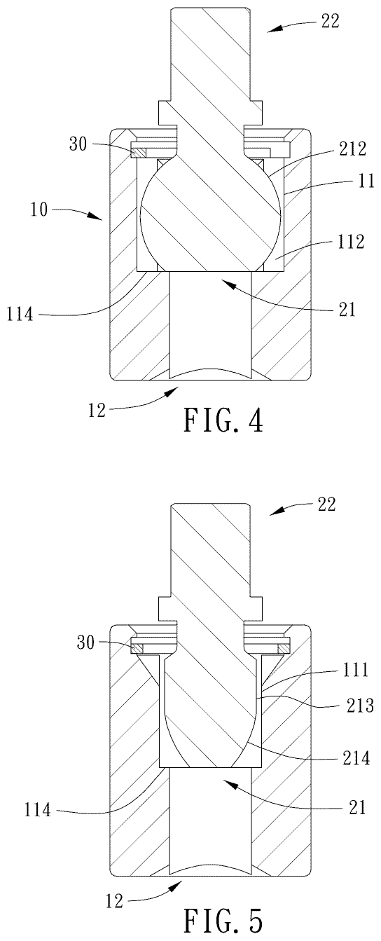

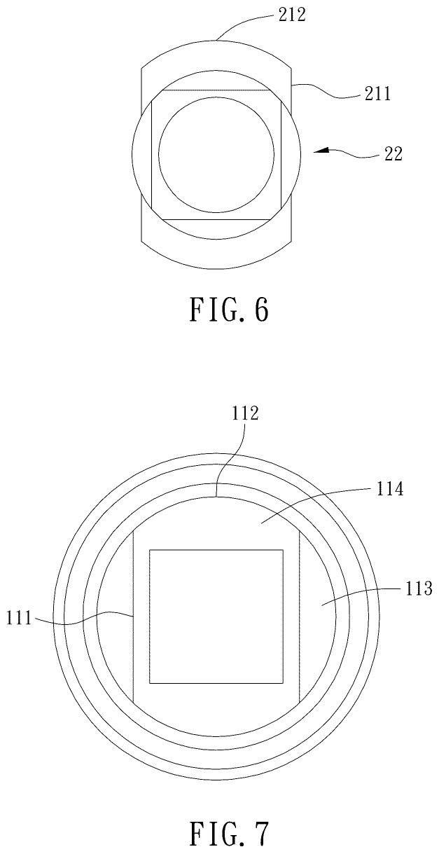

Please refer to FIGS. 1 to 7 for an exemplary embodiment of the present invention. A universal joint 1 of the present invention includes a socket 10 and a connecting rod 20.

The socket 10 includes a connecting slot 11 and an assembling structure 12 oppositely arranged. The connecting slot 11 includes a plurality of first inner surfaces 111 and a plurality of second inner surfaces 112, the plurality of first inner surfaces 111 and the plurality of second inner surfaces 112 are different in shape and are alternately and circumferentially arranged. The assembling structure 12 is configured to be assembled with a first external device (e.g., a hand tool, power tool connector, a connecting rod, a tool head, or the like). The connecting rod 20 includes a first end portion 21 and a second end portion 22 oppositely arranged. The first end portion 21 is swingably received in the connecting slot 11 and is rotatable with the socket 10. The first end portion 21 includes a plurality of first side surfaces 211 and a plurality of second side surfaces 212, and the plurality of first side surfaces 211 and the plurality of second side surfaces 212 are different in shape and are alternately and circumferentially arranged. The plurality of first side surfaces 211 and the plurality of second side surfaces 212 face the plurality of first inner surfaces 111 and the plurality of second inner surfaces 112, respectively. The second end portion 22 is configured to be assembled with a second external device (e.g., a hand tool, power tool connector, a connecting rod, a tool head, or the like). This configuration enables the connecting rod 20 to operate flexibly, smoothly and multi-directionally, with a large swinging range, and ensures effective torque transmission between the socket 10 and the connecting rod 20.

The plurality of first inner surfaces 111 and the plurality of second inner surfaces 112 extend axially along the socket 10. The plurality of first inner surfaces 111 are planar, and the plurality of second inner surfaces 112 are arcuate surfaces extending circumferentially around the axial direction of the socket 10. Each of the plurality of first side surfaces 211 extends linearly between neighboring two of the plurality of second side surfaces 212, and the plurality of second side surfaces 212 are radially convex arcuate surfaces. Each of the plurality of first side surfaces 211 includes a flat surface 213 and an arcuate surface 214 extending from the flat surface 213 toward a distal end of the first end portion 21. The planar configuration of the plurality of first inner surfaces 111 and the first side surfaces 211 provides a large and stable contact area, offering a strong and reliable surface contact mechanism that significantly enhances torque transmission efficiency between the socket 10 and the connecting rod 20 while minimizing damage.

Specifically, the plurality of first inner surfaces 111 and the plurality of second inner surfaces 112 are diametrically arranged on the socket 10, ensuring uniform contact areas and torque transmission. However, the arrangement may not necessarily be diametrical. The connecting slot 11 and the first end portion 21 are wide and flat, which contributes to improved torque transmission performance. The connecting rod 20 further includes a necked portion 23, and the necked portion 23 connected between the first end portion 21 and the second end portion 22, facilitating the swinging motion of the connecting rod 20. Optionally, the assembling structure 12 is a polygonal connecting hole (e.g., a quadrilateral connecting hole), and the second end portion 22 is a polygonal connecting head (e.g., a quadrilateral connecting head). Preferably, the shape of the assembling structure 12 matches that of the second end portion 22, allowing universal joints to be connected in series to meet various usage requirements.

In this embodiment, the connecting slot 11 further includes a plurality of inclined surfaces 113. Each of the plurality of inclined surfaces 113 extends gradually outward from one of the plurality of first inner surfaces 111 toward a periphery of an end of the socket 10. In a circumferential direction of the socket 10, two ends of each of the plurality of inclined surfaces 113 are connected to neighboring two of the plurality of second inner surfaces 112, respectively. The plurality of inclined surfaces 113 provides large space to increase the swinging range of the connecting rod 20.

Preferably, the universal joint 1 further includes a retainer 30. The retainer 30 is positioned to the socket 10 and restricts the first end portion 21 to be within the connecting slot 11, ensuring that the connecting rod 20 does not separate from the socket 10, thereby providing safety and reliability. The connecting slot 11 further includes a bottom surface 114. The first end portion 21 is restricted between the bottom surface 114 and the retainer 30 and is axially movable between the bottom surface 114 and the retainer 30. This restricts the axial movement distance of the connecting rod 20, thereby extending the operable range of the universal joint 1.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A universal joint including:
a socket including a connecting slot and a assembling structure oppositely arranged, the connecting slot including a plurality of first inner surfaces and a plurality of second inner surfaces, the plurality of first inner surfaces and the plurality of second inner surfaces being different in shape and being alternatively and circumferentially arranged, the assembling structure being configured to be assembled with a first external device; and
a connecting rod including a first end portion and a second end portion oppositely arranged, the first end portion being swingably received in the connecting slot and rotatable with the socket, the first end portion including a plurality of first side surfaces and a plurality of second side surfaces, the plurality of first side surfaces and the plurality of second side surfaces being different in shape and being alternatively and circumferentially arranged, the plurality of first side surfaces and the plurality of second side surfaces facing the plurality of first inner surfaces and the plurality of second inner surfaces, respectively, the second end portion being configured to be assembled with a second external device.

2. The universal joint of claim 1, wherein the plurality of first inner surfaces and the plurality of second inner surfaces extend axially along the socket, the plurality of first inner surfaces being planar, the plurality of second inner surfaces being arcuate surfaces extending circumferentially around an axial direction of the socket, each of the plurality of first side surfaces extends linearly between neighboring two of the plurality of second side surfaces, and the plurality of second side surfaces are arcuate surfaces which are radially convex.

3. The universal joint of claim 2, wherein each of the plurality of first side surfaces includes a flat surface and an arcuate surface extending from the flat surface toward a distal end of the first end portion.

4. The universal joint of claim 1, further including a retainer, wherein the retainer is positioned to the socket and restricts the first end portion to be within the connecting slot.

5. The universal joint of claim 4, wherein the connecting slot further includes a bottom surface, the first end portion is restricted between the bottom surface and the retainer, and the first end portion is axially movable between the bottom surface and the retainer.

6. The universal joint of claim 2, wherein the connecting slot further includes a plurality of inclined surfaces, each of the plurality of inclined surfaces extends gradually outward from one of the plurality of first inner surfaces toward a periphery of an end of the socket.

7. The universal joint of claim 6, wherein in a circumferential direction of the socket, two ends of each of the plurality of inclined surfaces are connected to neighboring two of the plurality of second inner surfaces, respectively.

8. The universal joint of claim 3, wherein every two of the plurality of first inner surfaces and every two of the plurality of second inner surfaces are diametrically arranged; the connecting slot and the first end portion are wide and flat; the universal joint further includes a retainer, the retainer is positioned to the socket and restricts the first end portion to be within the connecting slot; the connecting slot further includes a bottom surface, the first end portion is restricted between the bottom surface and the retainer, and the first end portion is axially movable between the bottom surface and the retainer; the connecting slot further includes a plurality of inclined surfaces, each of the plurality of inclined surfaces extends gradually outward from one of the plurality of first inner surfaces toward a periphery of an end of the socket; in a circumferential direction of the socket, two ends of each of the plurality of inclined surfaces are connected to neighboring two of the plurality of second inner surfaces, respectively; and the connecting rod further includes a necked portion connected between the first end portion and the second end portion.

9. The universal joint of claim 1, wherein the assembling structure is a polygonal connecting hole, and the second end portion is a polygonal connecting head.

10. The universal joint of claim 9, wherein a shape of the assembling structure matches a shape of the second end portion.
